(19) United States
(12) Patent Application Publication
(10) Pub. No.: US 2024/0279450 A1
(43) Pub. Date: Aug. 22, 2024

(54) FILLED POLYOLEFIN COMPOSITION

(71) Applicant: Basell Poliolefine Italia S.r.l., Milano (IT)

(72) Inventors: Rainer Köhler, Pegnitz (DE); Mikhail Dureev, Butzbach (DE); Michele Grazzi, Ferrara (IT)

(73) Assignee: Basell Poliolefine Italia S.r.l., Milano (IT)

(21) Appl. No.: 18/568,213

(22) PCT Filed: Jun. 3, 2022
(86) PCT No.: PCT/EP2022/065248

§ 371 Date: Dec. 7, 2023

(30) Foreign Application Priority Data
Jun. 16, 2021 (EP) 21179696.6

(51) Int. Cl. C08L 23/16; B29C 45/00; B29K 23/00; B29K 309/08; B29L 31/30; C08F 2/34; C08F 10/14; C08J 5/04; C08K 7/14

(52) U.S. Cl. CPC C08L 23/16; B29C 45/0005; B29C 45/0055; C08F 2/34; C08F 10/14; C08J 5/043; C08K 7/14; B29K 2023/16; B29K 2309/08; B29L 2031/3005; B29L 2031/3055; C08J 2323/16; C08K 2201/003; C08K 2201/004; C08L 2205/035; C08L 2205/08; C08L 2207/02; C08L 2314/02

(57) ABSTRACT

A filled polyolefin composition made from or containing a blend of a 30-70 wt. % of a first heterophasic polypropylene (HECO1) and 70-30 wt. % of a second heterophasic polypropylene (HECO2), wherein the heterophasic copolymers differ in MFR and type of comonomers, in combination with glass fibers and optionally a compatibilizer.

### FIELD OF THE INVENTION

In general, the present disclosure relates to the field of chemistry. More specifically, the present disclosure relates to polymer chemistry. In particular, the present disclosure relates to a filled polyolefin composition.

### BACKGROUND OF THE INVENTION

In some instances, filled polypropylene compounds based on heterophasic polyolefin compositions are used in the automotive industry, thereby obtaining injection molded parts, having aesthetical interior applications.

In some instances, glass fibers reinforced heterophasic polyolefin compositions provide a good balance of stiffness and impact, soft touch haptic, and good scratch resistance.

### SUMMARY OF THE INVENTION

In a general embodiment, the present disclosure provides a filled polymer composition made from or containing:
(a) 65-90% by weight of a polyolefin blend made from or containing
   (i) 30-70% by weight of a first heterophasic polypropylene (HECO1) made from or containing
      (A1) 10-40% by weight of a copolymer of propylene with hexene-1 made from or containing 1.0-6.0% by weight of units deriving from hexene-1, based on the weight of (A1), and having a melt flow rate MFR(A1), measured according to ISO 1133, 230° C., 2.16 kg, equal to or greater than 20 g/10 min; and
      (B1) 60-90% by weight of a copolymer of propylene with an alpha-olefin of formula CH₂—CHR, and optionally a diene, wherein R is H or a linear or branched C²-C⁸ alkyl, made from or containing 20-35% by weight of monomer units deriving from the alpha-olefin, based on the weight of (B1),
      wherein
         the first heterophasic polypropylene (HECO1) has an amount of fraction soluble in xylene (XS1) at 25° C. equal to or higher than 65% by weight, and
         the amounts of (A1), (B1), and XS1 are based on the total weight of (A1)+(B1); and
   (ii) 70-30% by weight of a second heterophasic polypropylene (HECO2), having a melt flow rate MFR(2), measured according to ISO 1133, 230° C., 2.16 kg, equal to or greater than 80 g/10 min. and made from or containing
      (A2) 75-90% by weight of a propylene homopolymer or a propylene copolymer with an alpha-olefin of formula CH₂—CHR, wherein R is H or a linear or branched C²-C⁸ alkyl, wherein the copolymer is made from or containing up to and including 10% by weight of monomer units deriving from the alpha-olefin, based on the weight of (A2); and
      (B2) 10-25% by weight of a copolymer of propylene with an alpha-olefin of formula CH₂═CHR, and optionally a diene, wherein R is H or a linear or branched C²-C⁸ alkyl, made from or containing 30-60% by weight of monomer units deriving from the alpha-olefin, based on the weight of (B2), wherein the amounts of (A2) and (B2) being based on the total weight of (A2)+(B2),
   wherein the amounts of HECO1 and HECO2 are based on the total weight of HECO1+HECO2;
(b) 10-35% by weight of glass fibers; and
(c) 0-5% by weight of a compatibilizer,

wherein the amounts of (a), (b), and (c) are based on the total weight of (a)+(b)+(c).

While multiple embodiments are disclosed, still other embodiments will become apparent to those skilled in the art from the following detailed description. As will be apparent, certain embodiments, as disclosed herein, are capable of modifications in various aspects, without departing from the spirit and scope of the claims as presented herein. Accordingly, the following detailed description is to be regarded as illustrative in nature and not restrictive.

### DETAILED DESCRIPTION OF THE INVENTION

In the present disclosure, the percentages are expressed by weight, unless otherwise specified.

In the present disclosure, when the term “comprising” is referred to a polymer or to a polymer composition, mixture, or blend, the term should be construed to mean “comprising or consisting essentially of”.

In the present disclosure, the term “consisting essentially of” means that, in addition to the specified components, the polymer, the polyolefin composition, the polyolefin mixture, or the polyolefin blend may be further made from or containing other components provided that the characteristics of the polymer or of the composition, mixture or blend are not materially affected by the presence of the other components. In some embodiments, the other components are catalyst residues, antistatic agents, melt stabilizers, light stabilizers, antioxidants, and antiacids.

The total weight of a polymer or of a polymer composition sums up to 100%, unless otherwise specified.

In some embodiments, the filled polyolefin composition is made from or containing:
(a) 65-90% by weight, alternatively 70-85% by weight, of a polyolefin blend made from or containing
   (i) 30-70% by weight of a first heterophasic polypropylene (HECO1) made from or containing
      (A1) 10-40% by weight of a copolymer of propylene with hexene-1 made from or containing 1.0-6.0% by weight of units deriving from hexene-1, based on the weight of (A1), and having a melt flow rate MFR(A1), measured according to ISO 1133, 230° C., 2.16 kg, equal to or greater than 20 g/10 min; and
      (B1) 60-90% by weight of a copolymer of propylene with an alpha-olefin of formula CH₂—CHR, and optionally a diene, wherein R is H or a linear or branched C2-C8 alkyl, made from or containing 20-35% by weight of monomer units deriving from the alpha-olefin, based on the weight of (B1),
      wherein
         the first heterophasic polypropylene (HECO1) has an amount of fraction soluble in xylene (XS1) at 25° C. equal to or higher than 65% by weight, and
         the amounts of (A1), (B1), and XS1 are based on the total weight of (A1)+(B1); and
   (ii) 70-30% by weight of a second heterophasic polypropylene (HECO2), having a melt flow rate MFR(2), measured according to ISO 1133, 230° C., 2.16 kg, equal to or greater than 80 g/10 min. and made from or containing
      (A2) 75-90% by weight of a propylene homopolymer or a propylene copolymer with an alpha-olefin of formula CH₂═CHR, wherein R is H or a linear or branched C²-C⁸ alkyl, wherein the copolymer is made from or containing up to and including 10% by weight of monomer units deriving from the alpha-olefin, based on the weight of (A2); and
      (B2) 10-25% by weight of a of a copolymer of propylene with an alpha-olefin of formula CH₂═CHR, and optionally a diene, wherein R is H or a linear or branched C²-C⁸ alkyl, made from or containing 30-60% by weight of monomer units deriving from the alpha-olefin, based on the weight of (B2), wherein the amounts of (A2) and (B2) being based on the total weight of (A2)+(B2),
   wherein the amounts of HECO1 and HECO2 are based on the total weight of HECO1+HECO2;
(b) 10-35% by weight of glass fibers; and
(c) 0-5% by weight, alternatively 0.1-5% by weight, alternatively 0.5-3% by weigh, alternatively 0.7-2% by weight, of a compatibilizer; and wherein the amount of (a), (b), and (c) are based on the total weight of (a)+(b)+(c).

In some embodiments, the first heterophasic polypropylene (HECO1) is made from or containing a propylene copolymer (A1) made from or containing 2.0-5.0% by weight, alternatively 2.8-4.8% by weight, alternatively 3.0-4.0% by weight, of units deriving from hexene-1, based on the weight of component (A1).

In some embodiments, the propylene copolymer (A1) is made from or containing hexene-1 as the comonomer.

In some embodiments, the propylene copolymer (A1) is made from or containing hexene-1 and 0.1-3.0% by weight of an alpha-olefin selected from the group consisting of ethylene, butene-1, 4-methyl-1-pentene, octene-1, and combinations thereof, based on the weight of component (A1).

In some embodiments, the propylene copolymer (A1) has a melt flow rate MFR(A1), measured according to ISO 1133, 230° C., ranging from 20 to 120 g/10 min, alternatively from 25 to 100 g/10 min.

In some embodiments, the propylene copolymer (A1) has an amount of fraction soluble in xylene at 25° C. XS(A1) lower than 12.0% by weight, alternatively lower than 9.0% by weight, based on the weight of component (A1). In some embodiments, XS(A1) is in the range 5.0-12.0% by weight, alternatively 5.0-9.0% by weight, alternatively 6.0-8.0% by weight, based on the weight of component (A1).

In some embodiments, the propylene copolymer (B1) has an amount of fraction soluble in xylene at 25° C. XS(B1) equal to or greater than 80% by weight, alternatively equal to or greater than 85% by weight, alternatively equal to or greater than 90% by weight, based on the total weight of component (B1).

In some embodiments, the upper limit of the amount of the fraction of component (B1) soluble in xylene at 25° C. XS(B1) is 97% by weight for each lower limit, based on the total weight of component (B1).

In some embodiments, component (B1) is made from or containing a first copolymer (B1.1) and a second copolymer (B1.2) of propylene with an alpha-olefin of formula CH₂═CHR, and optionally a diene, wherein R is H or a linear or branched C2-C8 alkyl, provided that the total amount of alpha-olefin in the propylene copolymer (B1) is 20-35% by weight, based on the total weight of component (B1).

In some embodiments, component (B1) is made from or containing:
(B1.1) 30-60% by weight, alternatively 40-55% by weight, of a first copolymer of propylene with an alpha-olefin of formula CH₂—CHR, and optionally a diene, where R is H or a linear or branched C²-C⁸ alkyl, made from or containing 20-40% by weight, alternatively 25-35% by weight of alpha-olefin, and has a fraction soluble in xylene at 25° C. XS(B1.1) equal to or greater than 80% by weight, alternatively equal to or greater than 85% by weight, alternatively equal to or greater than 90% by weight, the amount of alpha-olefin and of XS(B1.1) being based on the weight of component (B1.1); and
(B1.2) 40-70% by weight, alternatively 45-60% by weight, of a second copolymer of propylene with an alpha-olefin of formula CH₂═CHR, and optionally a diene, wherein R is H or a linear or branched C²-C⁸ alkyl, made from or containing 25-45% by weight, alternatively 30-43% by weight, of alpha-olefin, and has a fraction soluble in xylene at 25° C. XS(B1.2) equal to or greater than 80% by weight, alternatively equal to or greater than 85% by weight, alternatively equal to or greater than 90% by weight, the amount of alpha-olefin and of XS(B1.2) being based on the weight of component (B1.2),
   wherein the amounts of (B1.1) and (B1.2) are based on the total weight of (B1.1)+(B1.2).

In some embodiments, the upper limit of XS(B1.1) or of XS(B1.2) is 97% by weight for each lower limit, XS(B1.1) and XS(B1.2) being based on the weight of component (B1.1) and (B1.2) respectively.

In some embodiments, the first heterophasic polypropylene (HECO1) has an amount of fraction soluble in xylene at 25° ° C. XS(1) equal to or greater than 70% by weight, alternatively ranging from 71 to 90% by weight, alternatively from 72 to 80% by weight, based on the total weight of (A1)+(B1).

In some embodiments, the first heterophasic polypropylene (HECO1) has a melt flow rate MFR(1), measured according to ISO 1133, 230° C., 2.16 kg, ranging from 5 to 50 g/10 min., alternatively from 10 to 30 g/10 min., alternatively from 12 to 25 g/10 min.

In some embodiments, the melt flow rate MFR(1) of the first heterophasic polypropylene (HECO1), measured according to ISO 1133, 230° C., 2.16 kg, ranges from 5 to 50 g/10 min., alternatively from 10 to 30 g/10 min., alternatively from 12 to 25 g/10 min. and is obtained by visbreaking the heterophasic polypropylene obtained from the polymerization reaction.

In some embodiments, the visbreaking is carried out by mixing the polyolefin with an organic peroxide in the molten state.

In some embodiments, the intrinsic viscosity of the fraction soluble in xylene XSIV(1) of the first heterophasic polypropylene (HECO1) is equal to or lower than 1.5 dl/g.

In some embodiments, the heterophasic polypropylene (HECO1) is made from or containing 15-35% by weight, alternatively 20-30% by weight, of component (A1) and 65-85% by weight, alternatively 70-80% by weight, of component (B1), wherein the amounts of (A1) and (B1) are based on the total weight of (A1)+(B1).

In some embodiments, the alpha-olefin of component (B1) is selected from the group consisting of ethylene, butene-1, hexene-1, 4-methy-pentene-1, octene-1, and combinations thereof. In some embodiments, the alpha-olefin of component (B1) is ethylene.

In some embodiments, propylene copolymer (B1) is made from or containing recurring units derived from a diene. In some embodiments, the diene is selected from the group consisting of butadiene, 1,4-hexadiene, 1,5-hexadiene, ethylidene-1-norbonene, and combinations thereof.

In some embodiments, the total amount of recurring units deriving from a diene ranges from 1 to 10% by weight, based on the weight of component (B1).

In some embodiments, the first heterophasic polypropylene (HECO1) is made from or containing:
(A1) 10-40% by weight, alternatively 15-35% by weight, alternatively 20-30% by weight, of a copolymer of propylene with hexene-1 made from or containing 1.0-6.0% by weight, alternatively 2.0-5.0% by weight, alternatively 2.8-4.8% by weight, alternatively 3.0-4.0% by weight, of hexene-1, based on the weight of component (A1), and having a melt flow rate MFR(A1), measured according to ISO 1133, 230° ° C., 2.16 kg, equal to or greater than 20 g/10 min., alternatively equal to or greater than 25 g/10 min., alternatively ranging from 20 to 120 g/10 min, alternatively from 25 to 100 g/10 min; and
(B1) 60-90% by weight, alternatively 65-85% by weight, alternatively 70-80% by weight, of a copolymer of propylene with ethylene made from or containing 20-35% by weight of ethylene, based on the total weight of component (B1),
wherein the first heterophasic polypropylene (HECO1):
   has an amount of fraction soluble in xylene at 25° C. XS(1) equal to or greater than 65% by weight, alternatively equal to or greater than 70% by weight, alternatively ranging from 71 to 90% by weight, alternatively from 72 to 80% by weight;
   has a melt flow rate MFR(1), measured according to ISO 1133, 230° ° C., 2.16 kg, ranging from 5 to 50 g/10 min., alternatively from 10 to 30 g/10 min., alternatively from 12 to 25 g/10. min., wherein the MFR(1) being obtained by visbreaking the heterophasic polypropylene obtained from the polymerization reaction, and wherein the amounts of (A1), (B1), and XS(1) are based on the total weight of (A1)+(B1).

In some embodiments, the first heterophasic polypropylene (HECO1) has a property selected from the following mechanical properties:
a flexural modulus ranging from 50 to 90 MPa, alternatively from 60 to 85 MPa, alternatively from 65 to 80 MPa, measured according to ISO 178:2019 on 4 mm-thick injection molded specimens obtained according to the method ISO 1873-2:2007; or
a Shore A value equal to or lower than 90, measured on compression molded plaques according to method ISO 868 (15 sec); or
a Shore D value equal to or lower than 30, measured on compression molded plaques according to method ISO 868 (15 sec).

In some embodiments, the Shore A value is in the range 70-90. In some embodiments, the Shore D value is in the range 23-30. In some embodiments, the first heterophasic polypropylene (HECO1) has flexural modulus, Shore A, and Shore D values in the ranges indicated above.

In some embodiments, the first heterophasic polypropylene (HECO1) is prepared by a sequential polymerization process, including at least two stages, wherein the second and each subsequent polymerization stage is carried out in the presence of the polymer produced and the catalyst, which was present in the immediately preceding polymerization stage.

In some embodiments, the polymerization processes are carried out in the presence of a catalyst selected from the group consisting of metallocene compounds, highly stereospecific Ziegler-Natta catalyst systems, and combinations thereof.

In some embodiments, the polymerization processes are carried out in the presence of a highly stereospecific Ziegler-Natta catalyst system comprising:
(1) a solid catalyst component made from or containing a magnesium halide support on which a Ti compound having at least a Ti-halogen bond is present, and a stereoregulating internal donor;
(2) optionally, an Al-containing cocatalyst; and
(3) optionally, a further electron-donor compound (external donor). In some embodiments, the stereospecific Ziegler-Natta catalyst system is further made from or containing the Al-containing cocatalyst. In some embodiments, the stereospecific Ziegler-Natta catalyst system is further made from or containing the electron-donor compound (external donor).

In some embodiments, the solid catalyst component (1) is made from or containing a titanium compound of formula Ti(OR)ₙX_{y_n}, wherein n is between 0 and y; y is the valence of titanium; X is halogen and R is a hydrocarbon group having 1-10 carbon atoms or a —COR group. In some embodiments, titanium compounds having a Ti-halogen bond is selected from the group consisting of titanium tetrahalides and titanium halogenalcoholates. In some embodiments, the titanium compounds are selected from the group consisting of TiCl₃, TiCl₄, Ti(OBu)+, Ti(OBu)Cl₃, Ti(OBu)₂Cl₂, and Ti(OBu)₃Cl. In some embodiments, the titanium compound is TiCl₄.

In some embodiments, the solid catalyst component (1) is made from or containing a titanium compound in an amount providing from 0.5 to 10% by weight of Ti with respect to the total weight of the solid catalyst component (1).

In some embodiments, the solid catalyst component (1) is made from or containing a stereoregulating internal electron donor compound selected from mono or bidentate organic Lewis bases. In some embodiments, the solid catalyst component (1) is made from or containing a stereoregulating internal electron donor compound selected from the group consisting of esters, ketones, amines, amides, carbamates, carbonates, ethers, nitriles, alkoxysilanes, and combinations thereof.

In some embodiments, the electron donors are selected from the group consisting of aliphatic or aromatic mono- or dicarboxylic acid esters and diethers.

In some embodiments, the alkyl and aryl esters of optionally substituted aromatic polycarboxylic acids are selected from the group consisting of esters of phthalic acids. In some embodiments, the esters of phthalic acids are as described in European Patent Application Nos. EP45977A2 and EP395083A2.

In some embodiments, the internal electron donor is selected from the group consisting of mono- or di-substituted phthalates, wherein the substituents are independently selected from the group consisting of linear or branched C₁-10 alkyl, C₃-8 cycloalkyl and aryl radicals.

In some embodiments, the internal electron donor is selected from the group consisting of di-isobutyl phthalate, di-n-butyl phthalate, di-n-octyl phthalate, diphenyl phthalate, benzylbutyl phthalate, and combinations thereof.

In some embodiments, the internal electron donor is di-isobutyl phthalate.

In some embodiments, the esters of aliphatic acids are selected from malonic acids, glutaric acids, or succinic acids. In some embodiments, the esters of malonic acids are as described in Patent Cooperation Treaty Publication Nos. WO98/056830, WO98/056833, and WO98/056834. In some embodiments, the esters of glutaric acids are as described in Patent Cooperation Treaty Publication No. WO00/55215. In some embodiments, the esters of succinic acids are as described in Patent Cooperation Treaty Publication No. WO00/63261.

In some embodiments, the diesters are derived from esterification of aliphatic or aromatic diols. In some embodiments, the diesters are as described in Patent Cooperation Treaty Publication No. WO2010/078494 and U.S. Pat. No. 7,388,061.

In some embodiments, the internal electron donor is selected from 1,3-diethers of formula

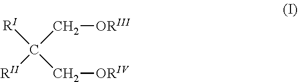

wherein R^{I} and R^{II} are independently selected from C₁₋₁₈ alkyl, C₃₋₁₈ cycloalkyl and C⁷⁻¹⁸ aryl radicals, R^{III} and R^{IV} are independently selected from C₁₋₄ alkyl radicals; or the carbon atom in position 2 of the 1,3-diether belongs to a cyclic or polycyclic structure made up of from 5 to 7 carbon atoms, or of 5-n or 6-n′ carbon atoms, and respectively n nitrogen atoms and n′ heteroatoms selected from the group consisting of N, O, S, and Si, where n is 1 or 2 and n′ is 1, 2, or 3, wherein the structure containing two or three unsaturations (cyclopolyenic structures), and optionally being condensed with other cyclic structures, or substituted with one or more substituents selected from the group consisting of linear or branched alkyl radicals; cycloalkyl, aryl, aralkyl, alkaryl radicals, and halogens, or being condensed with other cyclic structures and substituted with one or more, wherein one or more of the alkyl, cycloalkyl, aryl, aralkyl, or alkaryl radicals and the condensed cyclic structures optionally contain one or more heteroatom(s) as substitutes for carbon or hydrogen atoms. In some embodiments, the substituents are bonded to the condensed cyclic structures. In some embodiments, the ethers are as described in European Patent Application Nos. EP361493 and EP728769 or Patent Cooperation Treaty Publication No. WO02/100904.

In some embodiments, 1,3-diethers are used and the external electron donor (3) is absent.

In some embodiments, mixtures of internal donors are used. In some embodiments, the mixtures are between aliphatic or aromatic mono or dicarboxylic acid esters and 1,3-diethers as described in Patent Cooperation Treaty Publication Nos. WO07/57160 and WO2011/061134.

In some embodiments, the magnesium halide support is magnesium dihalide.

In some embodiments, the amount of internal electron donor which remains fixed on the solid catalyst component (1) is 5 to 20% by moles, with respect to the magnesium dihalide.

In some embodiments, preparation of the solid catalyst components involves a reaction of Mg dihalide precursors with titanium chlorides to form the Mg dihalide support. In some embodiments, the reaction is carried out in the presence of the stereoregulating internal donor.

In some embodiments, the magnesium dihalide precursor is a Lewis adduct of formula MgCl₂·nR1OH, wherein n is a number between 0.1 and 6, and R1 is a hydrocarbon radical having 1-18 carbon atoms. In some embodiments, n ranges from 1 to 5, alternatively from 1.5 to 4.5.

In some embodiments, the adduct is prepared by mixing alcohol and magnesium chloride, operating under stirring conditions at the melting temperature of the adduct (100-130° C.).

Then, the adduct is mixed with an inert hydrocarbon immiscible with the adduct, thereby creating an emulsion which is quickly quenched causing the solidification of the adduct in the form of spherical particles.

In some embodiments, the resulting adduct is directly reacted with the Ti compound or subjected to thermal controlled dealcoholation (80-130° C.), thereby obtaining an adduct wherein the number of moles of alcohol is lower than 3, alternatively between 0.1 and 2.5.

In some embodiments, this controlled dealcoholation step is carried out to increase the morphological stability of the catalyst during polymerization or to increase the catalyst porosity as described in European Patent Application No. EP395083A2.

In some embodiments, the reaction with the Ti compound is carried out by suspending the optionally-dealcoholated adduct in cold TiCl₄. In some embodiment, cold TiCl₄ is at 0° C.). In some embodiments, the mixture is heated up to 80-130° C. and kept at this temperature for 0.5-2 hours. In some embodiments, the treatment with TiCl₄ is carried out one or more times. In some embodiments, the stereoregulating internal donor is added during the treatment with TiCl₄. In some embodiments, the treatment with the internal donor is repeated one or more times.

In some embodiments, the preparation of catalyst is as described in U.S. Pat. Nos. 4,399,054, 4,469,648, Patent Cooperation Treaty Publication No. WO98/44009A1, or European Patent Application No. EP395083A2.

In some embodiments, the catalyst component (1) is in the form of spherical particles having an average diameter ranging from 10 to 350 μm, a surface area ranging from 20 to 250 m²/g, alternatively from 80 to 200 m²/g, and a porosity greater that 0.2 ml/g, alternatively of from 0.25 to 0.5 ml/g, wherein the surface area and the porosity are measured by BET.

In some embodiments, the catalyst system is made from or containing an Al-containing cocatalyst (2). In some embodiments, the Al-containing cocatalyst (2) is selected from the group consisting of Al-trialkyls, alternatively the group consisting of Al-triethyl, Al-triisobutyl, and Al-tri-n-butyl.

In some embodiments, the Al/Ti weight ratio in the catalyst system is from 1 to 1000, alternatively from 20 to 800.

In some embodiments, the catalyst system is further made from or containing electron donor compound (3) (external electron donor). In some embodiments, the external electron donor is selected from the group consisting of silicon compounds, ethers, esters, amines, heterocyclic compounds, and ketones. In some embodiments, the heterocyclic compound is 2,2,6,6-tetramethylpiperidine.

In some embodiments, the external donor is selected from the group consisting of silicon compounds of formula (R2)a(R3)bSi(OR4)c, where a and b are integers from 0 to 2, c is an integer from 1 to 4, and the sum (a+b+c) is 4; R2, R3, and R4, are alkyl, cycloalkyl or aryl radicals with 1-18 carbon atoms, optionally containing heteroatoms. In some embodiments, a is 1, b is 1, c is 2, at least one of R2 and R3 is selected from branched alkyl, cycloalkyl or aryl groups with 3-10 carbon atoms, optionally containing heteroatoms, and R4 is a C1-C10 alkyl group. In some embodiments, R4 is a methyl group.

In some embodiments, the silicon compounds are selected from the group consisting of methylcyclohexyldimethoxysilane (C-donor), diphenyldimethoxysilane, methyl-t-butyldimethoxysilane, dicyclopentyldimethoxysilane (D-donor), diisopropyldimethoxysilane, (2-ethylpiperidinyl)t-butyldimethoxysilane, (2-ethylpiperidinyl) thexyldimethoxysilane, (3,3,3-trifluoro-n-propyl)(2-ethylpiperidinyl)dimethoxysilane, methyl(3,3,3-trifluoro-n-propyl)dimethoxysilane, and combinations thereof.

In some embodiments, the silicon compounds are wherein a is 0, c is 3, R3 is a branched alkyl or cycloalkyl group, optionally containing heteroatoms, and R4 is methyl. In some embodiments, the silicon compounds are selected from the group consisting of cyclohexyltrimethoxysilane, t-butyltrimethoxysilane, and hexyltrimethoxysilane.

In some embodiments, the catalyst system is made from or containing di-isobutyl phthalate as internal electron donor and dicyclopentyl dimethoxy silane (D-donor) as external electron donor.

In some embodiments, the catalyst system is pre-contacted with small quantities of olefin (prepolymerization), maintaining the catalyst in suspension in a hydrocarbon solvent and polymerizing at temperatures from 25° to 60° C., thereby producing a quantity of polymer from about 0.5 to about 3 times the weight of the catalyst system.

In some embodiments, the prepolymerization is carried out in liquid monomer, thereby producing a quantity of polymer 1000 times the weight of the catalyst system.

In some embodiments, sequential polymerization processes for preparing the first heterophasic polypropylene (HECO1) are as described in European Patent No. EP472946 and Patent Cooperation Treaty Publication No. WO03/011962, which content is incorporated in this patent application.

In some embodiments, components (A1) and (B1) are produced in any of the polymerization stages.

In some embodiments, the process to prepare the first heterophasic polypropylene (HECO1) includes at least two polymerization stages carried out in the presence of a highly stereospecific Ziegler-Natta catalyst system, wherein:
(a) in the first copolymerization stage, monomers are polymerized to form the propylene copolymer (A1); and
(b) in the second copolymerization stage, the relevant monomers are polymerized to form the propylene copolymer (B1), thereby obtaining polymer granules.

In some embodiments, the second copolymerization stage (b) includes a first copolymerization stage (b1) and a second copolymerization stage (b2), wherein the appropriate comonomers are polymerized to form the propylene copolymer (B1.1) in the first copolymerization stage (b1) and the appropriate comonomers are polymerized to form the propylene copolymer (B1.2) in the second copolymerization stage (b2).

In some embodiments, the polymerization is continuous or batch. In some embodiments, the polymerization is carried out according to cascade techniques, operating either in mixed liquid phase/gas phase or totally in gas phase.

In some embodiments, the liquid-phase polymerization is in slurry, solution, or bulk (liquid monomer). In some embodiments, the liquid-phase polymerization is carried out in various types of reactors. In some embodiments, the reactors are continuous stirred tank reactors, loop reactors, or plug-flow reactors.

In some embodiments, the gas-phase polymerization stages are carried out in gas-phase reactors. In some embodiments, the gas-phase reactors are fluidized or stirred, fixed bed reactors.

In some embodiments, the copolymerization stage (a) is carried out in liquid phase, using liquid propylene as diluent. In some embodiments, the copolymerization stage (b), or the copolymerization stages (b1) and (b2), are carried out in the gas phase.

In some embodiments, the copolymerization stage (a) is carried out in the gas phase.

In some embodiments, the reaction temperatures of the polymerization stages (a) and (b) are independently selected in the range from 40° to 90° C.

In some embodiments, the polymerization pressure of the copolymerization stage (a) carried out in liquid phase is from 3.3 to 4.3 MPa.

In some embodiments, the polymerization pressure of the copolymerization stages (a), and (b) carried out in gas-phase is independently selected in the range from 0.5 to 3.0 MPa.

In some embodiments, the residence time of each polymerization stage depends upon the ratio of component (A1) to component (B1). In some embodiments, the residence time in each polymerization stage ranges from 15 minutes to 8 hours.

In some embodiments and in a sequential polymerization process, the amounts of components (A1) and (B1) correspond to the split between the polymerization reactors.

In some embodiments, the molecular weight of the propylene copolymers obtained in each polymerization stage is regulated using chain transfer agents. In some embodiments, the chain transfer agent is hydrogen or ZnEt₂

In some embodiments, the process to prepare the first heterophasic polypropylene (HECO1) includes a step of melt mixing the polymer granules with an organic peroxide or an additive (C) selected from the group consisting of antistatic agents, anti-oxidants, anti-acids, melt stabilizers, and combinations thereof.

In some embodiments, the melt mixing step includes melt mixing the polymer granules with up to and including 1.0% by weight, alternatively from 0.01 to 0.8% by weight, alternatively from 0.01 to 0.5% by weight, of the additive (C) or up to and including 0.2% by weight, alternatively up to and including 0.1% by weight, of the organic peroxide, wherein:
the additive (C) is selected from the group consisting of antistatic agents, anti-oxidants, anti-acids, melt stabilizers, and combinations thereof; and
the amounts of the additive and of the organic peroxide are based on the weight of the polymer composition made from or containing the additives, the peroxide, or both.

In some embodiments, the first heterophasic polypropylene (HECO1) is made from or containing up to and including 1.0% by weight, alternatively from 0.01 to 0.8% by weight, alternatively from 0.01 to 0.5% by weight, of the additive (C) selected from the group consisting of antistatic agents, anti-oxidants, anti-acids, melt stabilizers and combinations thereof, and up to and including 0.2% by weight, alternatively up to and including 0.1% by weight, of an organic peroxide, wherein the amounts of the additive and of the organic peroxide are based on the weight of the polymer composition made from or containing the additive (C), the organic peroxide, or both.

In some embodiments, the lower limit of the amount of the organic peroxide is of 0.01% by weight for each lower limit, based on the weight of the polymer composition made from or containing the organic peroxide and optionally the additive (C).

In some embodiments, the first heterophasic polypropylene (HECO1) consists of component (A1) and (B1), the additive (C), and the organic peroxide.

In some embodiments, the second heterophasic polypropylene (HECO2) is different from the first heterophasic polypropylene (HECO1) and has a melt flow rate MFR(2), measured according to ISO 1133, 230° ° C., 2.16 kg, equal to or greater than 80 g/10 min, alternatively ranging from 80 to 150 g/10 min., alternatively from 90 to 120 g/10 min.

In some embodiments, the propylene polymer (A2) is made from or containing up to and including 10% by weight of units deriving from ethylene as the comonomer.

In some embodiments, the alpha-olefin of component (B2) is selected from the group consisting of ethylene, butene-1, hexene-1, 4-methy-pentene-1, octene-1, and combinations thereof. In some embodiments, the alpha-olefin of component (B2) is ethylene.

In some embodiments, the propylene copolymer (B2) is made from or containing recurring units derived from a diene. In some embodiments, the diene is selected from the group consisting of butadiene, 1,4-hexadiene, 1,5-hexadiene, ethylidene-1-norbonene, and combinations thereof.

In some embodiments, the total amount of recurring units deriving from a diene ranges from 1 to 10% by weight, based on the weight of component (B2).

In some embodiments, the second heterophasic polypropylene (HECO2) has a property selected from the following mechanical properties, measured on 4 mm-thick injection molded specimens obtained according to the method ISO 1873-2:2007:
a flexural modulus, measured according to the method ISO 178:2019, equal to or greater than 800 MPa, alternatively equal to or greater than 1000 MPa; or
a tensile modulus, measured according to the method ISO 527-1, -2, equal to or greater than 1000 MPa; or
a tensile stress at yield, measured according to the method ISO 527-1, -2, in the range 20-35 MPa; or
a tensile strain at yield, measured according to the method ISO 527-1, -2, in the range 3-10%; and/or
a Charpy impact strength (notched, 23° C.), measured according to the method ISO 179 1eA, ranging from 2.0 to 10; or
a Vicat A softening temperature, measured according to the method ISO 306 (A/50 N), equal to or greater than 145° C., alternatively in the range from 145° C. to 155° C.
   In some embodiments, the flexural modulus has an upper limit of 1300 MPa, alternatively 1200 MPa, for each lower limit. In some embodiments, the tensile modulus has an upper limit of 1400 MPa, alternatively 1300 MPa, for each lower limit.

In some embodiments, the second heterophasic polypropylene (HECO2) has the properties listed above.

In some embodiments, the second heterophasic polypropylene (HECO2) is prepared by a sequential polymerization process, including at least two stages, wherein the second and each subsequent polymerization stage is carried out in the presence of the polymer produced and the catalyst, which was present in the immediately preceding polymerization stage.

In some embodiments, the catalyst systems and the polymerization process for producing the first heterophasic polypropylene (HECO1) are for producing the second heterophasic polypropylene (HECO2).

In some embodiments, the second heterophasic polypropylene (HECO2) is made from or containing up to and including 0.5% by weight, alternatively from 0.01 to 0.5% by weight, alternatively from 0.01 to 0.3% by weight, of an additive (C) selected from the group consisting of antistatic agents, anti-oxidants, anti-acids, melt stabilizers and combinations thereof, based on the weight of a polymer composition made from or containing the second heterophasic polypropylene (HECO2) and the additive.

In some embodiments, the polyolefin composition is made from or containing glass fibers (b) having a diameter of up to and including 50 μm, alternatively ranging from 5 to 20 μm, alternatively from 8 to 15 μm, and a length equal to or lower than 10 mm, alternatively ranging from 0.1 to 10 mm, alternatively from 1 to 8 mm, alternatively from 2 to 6 mm.

In some embodiments, the glass fibers are e-glass fibers. In some embodiments, the glass fibers are sized fibers, that is, coated with a coupling agent, thereby increasing the compatibility of the fibers with the polymer into which the fibers are dispersed.

In some embodiments, compatibilizer (c) is present in the filled polyolefin composition. In some embodiments, compatibilizer (c) is a modified olefin polymer functionalized with a polar compound.

In some embodiments, the functionalized polar compound is selected from the group consisting of acid anhydrides, carboxylic acids, carboxylic acid derivatives, primary and secondary amines, hydroxyl compounds, oxazoline, epoxides, ionic compounds, and combinations thereof. In some embodiments, the functionalized polar compounds are selected from the group consisting of unsaturated cyclic anhydrides, related aliphatic diesters, and diacid derivatives.

In some embodiments, the compatibilizer (c) is a polyolefin functionalized with a compound selected from the group consisting of maleic anhydride, C¹-C¹⁰ linear or branched dialkyl maleates, C¹-C¹⁰ linear or branched dialkyl fumarates, itaconic anhydride, C¹-C¹⁰ linear or branched itaconic acid, dialkyl esters, maleic acid, fumaric acid, itaconic acid, and mixtures thereof. In some embodiments, the polyolefin is selected from the group consisting of polyethylenes, polypropylenes, and mixtures thereof.

In some embodiments, the compatibilizer (c) is a polyethylene or a polypropylene grafted with maleic anhydride (MAH-g-PP or MAH-g-PE).

In some embodiments, the modified olefin polymers functionalized with a polar compound are produced by functionalization processes carried out in solution, in the solid state, or in the molten state. In some embodiments, the modified olefin polymers are produced by functionalization processes carried out in the molten state. In some embodiments, the modified olefin polymers are produced by reactive extrusion of the polymer in the presence of the grafting compound and of a free radical initiator. In some embodiments, functionalization of polypropylene or polyethylene with maleic anhydride is as described in European Patent Application No. EP0572028A1.

In some embodiments, the modified polyolefins are selected from products commercially available under the trademark Amplify™ TY from The Dow Chemical Company, the trademark Exxelor™ from ExxonMobil Chemical Company, the trademark Scona® TPPP from Byk (Altana Group), the trademark Bondyram® from Polyram Group, the trademark Polybond® from Chemtura, and combinations thereof.

In some embodiments, the filled polyolefin composition is further made from or containing 0-15% by weight, alternatively 0.1-15% by weight, alternatively 0.5-10% by weight, of an additive (d) selected from the group consisting of fillers, pigments, nucleating agents, extension oils, flame retardants, UV resistants, UV stabilizers, lubricants, antiblocking agents, waxes, and combinations thereof, wherein the amount of the additive (d) being based on the total weight of (a)+(b)+(c)+(d). In some embodiments, the flame retardant is aluminum trihydrate. In some embodiments, the UV resistant is titanium dioxide. In some embodiments, the lubricant is oleamide.

In some embodiments, the filled polyolefin composition is further made from or containing a polymer (e) selected from the group consisting of:
propylene homopolymers;
propylene copolymers with an alpha-olefin of formula CH₂═CHR, wherein R is H or a linear or branched C²-C⁸ alkyl, made from or containing up to and including 12% by weight of monomer units deriving from the alpha-olefin, based on the weight of component (e);
saturated or unsaturated styrene or alpha-methylstyrene block copolymers;
ethylene homopolymers;
ethylene copolymers with an alpha-olefin of formula CH₂—CHR, wherein R is a linear or branched C²-C⁸ alkyl, and
combinations thereof. In some embodiments, the saturated or unsaturated styrene or alpha-methylstyrene block copolymers are made from or containing up to and including 30% by weight, alternatively from 10 to 30% by weight, alternatively from 15 to 25% by weight, of polystyrene, based on the weight of (e).

In some embodiments, the styrene block copolymer is selected from the group consisting of polystyrene-polybutadiene-polystyrene (SBS), polystyrene-poly(ethylene-butylene)-polystyrene (SEBS), polystyrene-poly(ethylene-propylene)-polystyrene (SEPS), polystyrene-polyisoprene-polystyrene (SIS), polystyrene-poly(isoprene-butadiene)-polystyrene (SIBS), and mixtures thereof. In some embodiments, the styrene block copolymer is a polystyrene-poly(ethylene-butylene)-polystyrene (SEBS).

In some embodiments, styrene or alpha-methylstyrene block copolymers are prepared by ionic polymerization of the relevant monomers. In some embodiments, styrene or alpha-methylstyrene block copolymers are commercially available under the tradename of Kraton™ from Kraton Polymers.

In some embodiments, the ethylene copolymer has at least 20% by weight, alternatively from 20 to 50% by weight, of units deriving from the alpha-olefin, based on the weight of the polymer (e). In some embodiments, the alpha-olefin is selected from the group consisting of butene-1, hexene-1, octene-1, and combinations thereof.

In some embodiments, the ethylene copolymers are commercially available under the tradename of Engage from The Dow Chemical Company. In some embodiments, the ethylene copolymers have the tradename Engage™ 8100 or Engage™ 8150. In some embodiments, the ethylene copolymers are prepared using solution polymerization processes carried out in the presence of a metallocene-based catalyst system.

In some embodiments, the amount of the further polymer (e) ranges from 0.5 to 20% by weight, alternatively from 3 to 20% by weight, alternatively from 5 to 15% by weight, the amount of the further polymer (e) being based on the total weight of (a)+(b)+(c)+(d)+(e).

In some embodiments, the filled polyolefin composition is prepared by metering the components to an extruder, operated at a temperature in the range from 180° to 280° C. In some embodiments, the extruder is a twin screw extruder.

The filled polyolefin composition of the instant disclosure has good flowability in the molten state having a melt flow rate MFR(tot), measured according to ISO 1133, 230° C., 2.16 kg, equal to or greater than 10 g/10 min., alternatively ranging from 10 to 50 g/10 min., alternatively from 12 to 30 g/10 min.

In some embodiments, the filled polyolefin composition has a property selected from the following properties:
a flexural modulus, measured according to the method ISO 178:2019, equal to or greater than 2500 MPa, alternatively equal to or greater than 2800 MPa; or
a Vicat A softening temperature, measured according to the method ISO 306 (A/50 N), equal to or greater than 130° C., alternatively equal to or greater than 135° C.; or
a Charpy impact strength (notched, 23° C.), measured according to the method ISO 179/1eA, equal to or greater than 25 KJ/m²; or
shrinkage 48h/RT equal to or lower than 0.20%, alternatively equal to or lower than 0.18% in longitudinal direction and equal to or lower than 0.85% in transverse direction; or
scratch resistance equal to or lower than 0.3.

In some embodiments, the flexural modulus is equal to or lower than 3500 MPa for each lower limit. In some embodiments, the Vicat A softening temperature is equal to or lower than 150° ° C. for each lower limit. In some embodiments, the Charpy impact strength (notched, 23° C.) is in the range 25-35 KJ/m². In some embodiments, the shrinkage 48h/RT in longitudinal and in transverse direction is equal to or greater than 0.05% for each upper limit. In some embodiments, the scratch resistance is in the range 0-0.3. The flexural modulus, the Vicat A softening temperature, and the Charpy impact strength were determined on injection-molded multipurpose bars, obtained according to EN ISO 20753 (Type A1).

In some embodiments, the filled polyolefin composition has the properties listed above.

In some embodiments, the present disclosure provides a process for producing a molded article, including the steps of:
(I) melt blending the filled polyolefin composition, thereby forming a molten filled polyolefin composition; and
(II) pushing the molten filled polyolefin composition into the cavity of a mold and solidifying the molten filled polyolefin composition inside the cavity.

In some embodiments, the process is carried out using an injection molding apparatus.

In some embodiments, the present disclosure provides an article made from or containing the filled polyolefin composition. In some embodiments, the article is an injection-molded article. In some embodiments, the injection molded article is selected from the group consisting of vehicle interior trims, vehicle exterior trims, and under the hood articles.

The features describing the filled polyolefin composition are not inextricably linked to each other. In some embodiments, a level of a feature does not involve the same level of the remaining features of the same or different components. In some embodiments, a range of features of components from (a) to (e) is combined independently from the level of other components.

### EXAMPLES

The following examples are illustrative and not intended to limit the scope of the disclosure in any manner whatsoever.

### Characterization Methods

The following methods are used to determine the properties indicated in the description and claims.

Melt Flow Rate: Determined according to the method ISO 1133 (230° C., 2.16 kg).

Solubility in xylene at 25° C.: 2.5 g of polymer sample and 250 ml of xylene were introduced into a glass flask equipped with a refrigerator and a magnetic stirrer. The temperature was raised in 30 minutes up to 135° C. The resulting clear solution was kept under reflux and stirred for further 30 minutes. The solution was cooled in two stages. In the first stage, the temperature was lowered to 100° C. in air for 10 to 15 minutes under stirring. In the second stage, the flask was transferred to a thermostatically-controlled water bath at 25° C. for 30 minutes. The temperature was lowered to 25° C., without stirring during the first 20 minutes, and maintained at 25° C., with stirring for the last 10 minutes. The formed solid was filtered on quick filtering paper (for example, Whatman filtering paper grade 4 or 541). 100 ml of the filtered solution (S1) was poured into a pre-weighed aluminum container, which was heated to 140° ° C. on a heating plate under nitrogen flow, thereby removing the solvent by evaporation. The container was then kept in an oven at 80° C. under vacuum until constant weight was reached. The amount of polymer soluble in xylene at 25° C. was then calculated. XS(tot) and XS_{A} values were experimentally determined. The fraction of component (B) soluble in xylene at 25° C. (XS_{B}) was calculated from the formula:

$$X S = W ( A ) \times ( X {S}_{A} ) + W ( B ) \times ( X {S}_{B} )$$

wherein W(A) and W(B) are the relative amounts of components (A) and (B), respectively, and W(A)+W(B)=1.

Intrinsic viscosity of the xylene soluble fraction: to calculate the value of the intrinsic viscosity IV, the flow time of a polymer solution was compared with the flow time of the solvent tetrahydronaphthalene (THN). A glass capillary viscometer of Ubbelohde type was used. The oven temperature was adjusted to 135° C. Before starting the measurement of the solvent flow time 10, the temperature was stable (135°±0.2° C.). Sample meniscus detection for the viscometer was performed by a photoelectric device.

Sample preparation: 100 ml of the filtered solution (S1) were poured into a beaker and 200 ml of acetone were added under vigorous stirring. Precipitation of insoluble fraction was completed as evidenced by a clear solid-solution separation. The suspension was filtered on a weighed metallic screen (200 mesh). The beaker was rinsed. The precipitate was washed with acetone, thereby removing the o-xylene. The precipitate was dried in a vacuum oven at 70° C. until a constant weight was reached. 0.05 g of precipitate were dissolved in 50 ml of tetrahydronaphthalene (THN) at a temperature of 135° C. The efflux time/of the sample solution was measured and converted into a value of intrinsic viscosity [η] using Huggins' equation (Huggins, M. L., J. Am. Chem. Soc. 1942, 64, 11, 2716-2718) and the following data:
concentration (g/dl) of the sample;
the density of the solvent at a temperature of 135° C.; and
the flow time to of the solvent at a temperature of 135° C. on the same viscometer.
   A single polymer solution was used to determine [η].

Comonomer content: determined by IR using Fourier Transform Infrared Spectrometer (FTIR). The spectrum of a pressed film of the polymer was recorded in absorbance vs. wavenumbers (cm⁻¹). The following measurements were used to calculate ethylene and hexene-1 content:
Area (At) of the combination absorption bands between 4482 and 3950 cm⁻¹, was used for spectrometric normalization of film thickness;
a linear baseline was subtracted in the range 790-660 cm⁻¹ and the remaining constant offset was eliminated; and
the contents of ethylene and hexene-1 were obtained by applying a Partial Least Square (PLS1) multivariate regression to the 762-688 cm⁻¹ range.
   The method was calibrated by using polymer standards based on 13C NMR analyses.
   Sample preparation: Using a hydraulic press, a thick sheet was obtained by pressing about 1 g of sample between two aluminum foils. Pressing temperature was 180±10° C. (356° F.), and about 10 kg/cm² pressure was applied for about one minute (minimum two pressing operations for each specimen). A small portion was cut from the sheet to mold a film. The film thickness was between 0.02-0.05 cm.

HDT A: measured according to the method ISO 75/A (1.8 MPa).

Flexural modulus: Determined according to the method ISO 178:2019.

Tensile strength and elongation: Determined according to the method ISO 527-1,-2.

Vicat A softening temperature: Determined according to the method ISO 306 (A/50N).

Charpy impact strength test at 23ºC: measured according to ISO 179/1eA 2010.

Preparation of compression molded plaques: obtained according to ISO 8986-2:2009.

Shore A and D on compression molded plaques: Determined according to the method ISO 868 (15 sec).

Thermal shrinkage: a plaque of 195×100×2.5 mm was molded in an injection molding machine Krauss Maffei KM250/1000C2 (250 tons of claiming force) under the following injection molding conditions:
melt temperature: 220° C.;
mold temperature: 35° C.;
injection time: 3.6 s;
holding time: 30 s; and
screw diameter: 55 mm
   The plaque was measured with a calipers, 48h after molding. The shrinkage was calculated from the following formulas:

$$\begin{matrix}longitudinal shrinkage = [ ( 195 - L ) / 195 ] \times 100 \\ transversal shrinkage = [ ( 100 - T ) / 100 ] \times 100\end{matrix}$$

wherein
195 and L are respectively the dimension of the mold and the measured dimensions of the plaque along the flow direction, in mm; and
100 and T are respectively the dimension of the mold and the measured dimensions of the plaque crosswise the flow direction, in mm.

Scratch resistance: measured according to the test specification WV PV 3952 (2021-03) on sample, cut out of out of a DIN A5 dimension grained with K85 type grain injection molded, using a loading weight of 10N.

### Preparation of HECO1

The component (a) of the filled polyolefin composition was prepared by a polymerization process carried out in two gas phase reactors, connected in series and equipped with devices to transfer the product from the first reactor to the second reactor. A Ziegler-Natta catalyst system was used made from or containing:
a titanium-containing solid catalyst component prepared as described in European Patent Application No. EP395083, Example 3, according to which di-isobutyl phthalate was used as internal electron donor compound;
triethylaluminium (TEAL) as co-catalyst; and
Dicyclopentyl dimethoxy silane (DCPMS) as external electron donor.

The solid catalyst component was contacted with TEAL and DCPMS in a pre-contacting vessel, with a weight ratio of TEAL to the solid catalyst component of 4-5. The weight ratio TEAL/DCPMS was 10.

The catalyst system was then subjected to pre-polymerization by suspending the catalyst system in liquid propylene at 20° C. for about 30-32 minutes before introducing the catalyst system into the first polymerization reactor.

Propylene copolymer (A1) was produced in the first gas phase reactor by feeding in a continuous and constant flow, the pre-polymerized catalyst system, hydrogen (used as molecular weight regulator), propylene, and hexene-1, in gaseous phase.

The propylene copolymer (A1), coming from the first reactor, was discharged in a continuous flow and, after having been purged of unreacted monomers, was introduced, in a continuous flow, into the second gas phase reactor, together with quantitatively constant flows of propylene, ethylene, and hydrogen, in the gas state. In the second reactor, the propylene copolymer (B1) was produced.

The polymerization conditions, molar ratio of the reactants, and composition of the copolymer obtained are shown in Table 1.

TABLE 1
GPR 1—component A1

| | | |
|---|---|---|
| Temperature | ° C. | 60 |
| Pressure | barg | 16 |
| H₂/C₃₋ | mol. | 0.04 |
| C₆₋/(C₆₋ + C₃₋) | mol | 0.03 |
| Split | wt % | 21 |
| Xylene soluble of A1 XS(A1) | wt % | 6.8 |
| MFR of A1 MFR(A1) | g/10 min. | 26 |
| C₆₋ content of A1 | wt % | 3.7 |

GPR 2—component B1

| | | |
|---|---|---|
| Temperature | ° C. | 55 |
| Pressure | barg | 16 |
| H₂/C₂₋ | mol. | 0.05 |
| C₂₋/(C₂₋ + C₃₋) | mol. | 0.15 |
| Split | wt % | 79 |
| C₂₋ content of B1 (*) | wt % | 27 |
| C₂₋ content of (A1 + B1) | wt % | 19.7 |
| MFR of (A1 + B1) | g/10 min. | 0.27 |

Notes
to table 1:
C₂₋ = ethylene in gas phase (IR);
C₃₋ = propylene in gas phase (IR);
C₆₋ = hexene-1 in gas phase (IR);
split = amount of polymer produced in the concerned reactor.
(*) indicates a calculated value.

The polymer particles exiting the second reactor were subjected to a steam treatment, thereby removing the unreacted monomers and volatile compounds, and then dried.

The first heterophasic polypropylene (HECO1) was prepared by mixing the polymer particles exiting the degassing section of the reactor with the additives (C) and an organic peroxide in the amounts indicated in Table 2, in a twin screw extruder Berstorff ZE 25 (length/diameter ratio of screws: 34) and extruded under nitrogen atmosphere in the following conditions:
rotation speed: 260 rpm;
extruder output: 18 kg/hour;
temperature profile: 160/200/200/210/220
melt temperature: 233° C.

TABLE 2

| | wt. % |
|---|---|
| Polymer particles | 99.705 |
| Ca stearate | 0.05 |
| Irganox 1010 | 0.05 |
| Irgafos 168 | 0.1 |
| Peroxan HX | 0.095 |

Irganox® 1010 was 2,2-bis[3-[,5-bis(1,1-dimethylethyl)-4-hydroxyphenyl]-1-oxopropoxy]methyl]-1,3-propanediyl-3,5-bis(1,1-dimethylethyl)-4-hydroxybenzene-propanoate; Irgafos® 168 was tris(2,4-di-tert.-butylphenyl)phosphite; Peroxan HX 2,5-dimethyl-2,5-di-(tert-butylperoxy)-hexane was commercially available from Pergan.

The properties of the first heterophasic polypropylene (HECO1) are reported in Table 3.

TABLE 3

| | | HECO1 |
|---|---|---|
| MFR | g/10 min | 14.7 |
| XS(1) | % | 69 |
| XSIV(1) | dl/g | 1.47 |
| Shore A | | 88 |
| Shore D | | 27 |

### Further Components

HECO2.1: an heterophasic polypropylene made from or containing 88 wt. % of a propylene-ethylene copolymer (A2.1) containing 5.3 wt. % of units deriving from ethylene, based on the weight of copolymer (A2.1), and 12 wt. % of a propylene-ethylene copolymer (B2.1) containing 44 wt. % of units deriving from ethylene, based on the weight of copolymer (B2.1), wherein the amounts of (A2.1) and (B2.1) being based on the total weight of (A2.1)+(B2.1).

The HECO2.1 had a MFR(2) of 100 g/10 min. (ISO1133, 230° C./2.16 Kg), a flexural modulus of 1200 MPa (ISO 178:2019), a tensile stress at yield of 30 MPa (ISO 527-1,-2), a tensile strain at yield of 7% (ISO 527-1,-2), a Charpy impact strength—notched at 23° C. (ISO 179, 1eA) of 2.5 KJ/m², and a Vicat softening temperature of 152° C. (ISO 306, A50).

HECO2.2: an heterophasic polypropylene made from or containing 82.5 wt. % of a propylene-ethylene copolymer (A2.2) containing 7.7 wt. % of units deriving from ethylene, based on the weight of the copolymer (A2.2), and 17.5 wt. % of a propylene ethylene copolymer (B2.2) containing 44 wt. % of units deriving from ethylene, based on the weight of the copolymer (B2.2), wherein the amounts of (A2.2) and (B2.2) are based on the total weight of (A2.2)+(B2.2).

The HECO2.2 had a MFR(2) of 100 g/10 min. (ISO1133, 230° C./2.16 Kg), a tensile modulus of 1200 MPa (ISO 527-1,-2), a tensile stress at yield of 26 MPa (ISO 527-1,-2), a tensile strain at yield of 6% (ISO 527-1,-2), a Charpy impact strength—notched at 23° C. (ISO 179, 1eA) of 5.0 kJ/m², and a Vicat softening temperature of 149° C. (ISO 306, A50).

ECS 03 T497: E-glass fibers (chopped strands), had a filament diameter of 13.0 μm and a strand length of 3.0 mm, commercially available from Nippon Electric Glass Co., Ltd.;

Chop Vantage® HP3270: chopped strands glass fibers silane-sized, having fiber diameter of 10 μm and 4.5 mm length, commercially available from Nippon Electric Glass;

Exxelor PO 1020: a propylene homopolymer grafted with maleic anhydride, having an MA grafting level in the range of 0.5-1.0 wt. %, commercially available from ExxonMobil;

BK MB: a polypropylene masterbatch made from or containing 40 wt. % of carbon black (ASTM D1603) and Moplen EP548S (commercially available from LyondellBasell) as carrier;

Premix: a mixture of additives made from or containing inorganic oxides, antioxidants, pigments, and 15.8 wt. % (with respect to the premix) of Moplen HF501N (commercially available from LyondellBasell) as carrier for the additives.

### Examples E1-E2

The filled polyolefin compositions, having the composition indicated in Table 4, were prepared by mixing the components in a 40 mm Werner & Pfleiderer extruder (L/D of 48), operated under the following extruding conditions:
rotation speed: 300 rpm;
temperature profile: 190/200/200/200/200/200; and
melt temperature: 245°−250° C.

The compositions were tested for physical and mechanical properties on multipurpose bars obtained by injection molding according to the method EN ISO 20753 (Type A1). The test results are reported in the Table 4.

### Comparative Example CE3

In Table 4, the test results were compared with the data reported in Table 2 of Patent Cooperation Treaty Publication No. WO2015/00078 for Reference No. 2. The composition of Reference No. 2 was made from or containing:
29.8 wt. % of a polymer (referred to as “HECO2”) made from or containing a 21 wt. % of a propylene copolymer containing 3.25 wt. % of ethylene, 49.5 wt. % of a propylene/ethylene copolymer containing 28 wt. % of ethylene, and 29.5 wt. % of a second propylene/ethylene copolymer containing 38 wt. % of ethylene, wherein the polymer having a MFR of 2.8 g/10 min. (ISO1133, 230° C./2.16 Kg);
38 wt. % of a polymer (referred to as “HECO3”), being an heterophasic polyolefin made from or containing 55 wt. % of a propylene homopolymer and 45 wt. % of a propylene/ethylene copolymer containing 12 wt. % of ethylene, wherein the polymer having a MFR of 18 g/10 min. (ISO1133, 230° C./2.16 Kg);
15 wt. % of a propylene homopolymer, having a MFR of 1800 g/10 min. (ISO1133, 230° C./2.16 Kg);
12 wt. % of glass fibers;
1 wt. % of polypropylene grafted with maleic anhydride; and
6 wt. % of an additive pack.

TABLE 4

| | | E1 | E2 | CE3 |
|---|---|---|---|---|
| HECO1 | wt. % | 40 | 40 | / |
| HECO2.1 | wt. % | 25.9 | / | |
| HECO2.2 | wt. % | / | 25.9 | |
| ECS 03 T497 | wt. % | 25 | 25 | |
| Exxelor PO 1020 | wt. % | 1 | 1 | |
| BK MB | wt. % | 2.6 | 2.6 | |
| Premix | wt. % | 5.5 | 5.5 | |
| MFR | g/10 min | 14.8 | 15.0 | 11.6 |
| HDT A | ° C. | 88.0 | 84.1 | 94.9 |
| Vicat A (A/50 N) | ° C. | 136.4 | 133.0 | / |
| Tensile strength at yield | MPa | 37.6 | 31.6 | / |
| Elongation at break | % | 14 | 16 | / |
| Flexural modulus | MPa | 2841 | 2589 | 2260 |
| Charpy impact | KJ/m² | 26.5 | 31.6 | 16.6 |
| notched at 23° C. | | | | |
| Shrinkage (48 h at 23° C.) | | | | |
| long. | % | 0.17 | 0.14 | 0.33 |
| transv. | % | 0.78 | 0.80 | 0.78 |

### Examples E4-E5

The filled polyolefin compositions of Table 5 were prepared by mixing the components in a 40 mm Werner & Pfleiderer extruder (L/D of 48), operated under the same extruding conditions used for examples E1-E2.

The compositions were tested for physical and mechanical properties on multipurpose bars obtained by injection molding according to the method EN ISO 20753 (Type A1). The test results are reported in Table 5.

TABLE 5

| | | E4 | E5 |
|---|---|---|---|
| HECO1 | wt. % | 27 | 27 |
| HECO2.1 | wt. % | 42.9 | / |
| HECO2.2 | wt. % | / | 42.9 |
| Chop Vantage HP 3270 | wt. % | 13 | 13 |
| Exxelor PO 1020 | wt. % | 1 | 1 |
| Kraton G1657 | wt. % | 7 | 7 |
| BK MB | wt. % | 3.4 | 3.4 |
| Premix | wt. % | 5.7 | 5.7 |
| MFR | g/10 min | 21.0 | 20.8 |
| HDT A | ° C. | 80.8 | 76.3 |
| Vicat A | ° C. | 140 | 134 |
| Tensile strength at yield | MPa | 31.8 | 29.4 |
| Elongation at break | % | 12 | 14 |
| Flexural modulus | MPa | 1970 | 1751 |
| Charpy impact | kJ/m² | 17.3 | 22.9 |
| notched at 23° C. | | | |
| Shrinkage (48 h at 23° C.) | | | |
| long. | % | 0.31 | 0.27 |
| transv. | % | 0.82 | 0.81 |
| Scratch resistance | | 0.1 | / |

1. A filled polymer composition comprising:
(a) 65-90% by weight of a polyolefin blend comprising
(i) 30-70% by weight of a first heterophasic polypropylene (HECO1) comprising
(A1) 10-40% by weight of a copolymer of propylene with hexene-1 comprising 1.0-6.0% by weight of units deriving from hexene-1, based on the weight of (A1), and having a melt flow rate MFR(A1), measured according to ISO 1133, 230° C., 2.16 kg, ranging from 20 to 120 g/10 min; and
(B1) 60-90% by weight of a copolymer of propylene with an alpha-olefin of formula CH₂—CHR, and optionally a diene, wherein R is H or a linear or branched C²-C⁸ alkyl, comprising 20-35% by weight of monomer units deriving from the alpha-olefin, based on the weight of (B1),
wherein
the first heterophasic polypropylene (HECO1) comprises an amount of fraction soluble in xylene (XS1) at 25° C. ranging from 71 to 90% by weight, and
the amounts of (A1), (B1) and XS1 are based on the total weight of (A1)+(B1); and
(ii) 70-30% by weight of a second heterophasic polypropylene HECO2, having a melt flow rate MFR(2), measured according to ISO 1133, 230° C., 2.16 kg, ranging from 80 to 150 g/10 min. and comprising:
(A2) 75-90% by weight of a propylene homopolymer or a propylene copolymer with an alpha-olefin of formula CH₂═CHR, wherein R is H or a linear or branched C²-C⁸ alkyl, wherein the copolymer comprising up to and including 10% by weight of monomer units deriving from the alpha-olefin, based on the weight of (A2); and
(B2) 10-25% by weight of a of a copolymer of propylene with an alpha-olefin of formula CH₂—CHR, and optionally a diene, wherein R is H or a linear or branched C2-C8 alkyl, comprising 30-60% by weight, based on the weight of (B2), of monomer units deriving from the alpha-olefin, based on the weight of (B2),
wherein the amounts of (A2) and (B2) are based on the total weight of (A2)+(B2), and
wherein the amounts of HECO1 and HECO2 are based on the total weight of HECO1+HECO2;
(b) 10-35% by weight of glass fibers; and
(c) 0-5% by weight of a compatibilizer,
wherein the amounts of (a), (b), and (c) are based on the total weight of (a)+(b)+(c).

2. The filled polyolefin composition of claim 1, wherein the propylene copolymer (A1) comprises 2.0-5.0% by weight of hexene-1, based on the weight of component (A1).

3. The filled polyolefin composition of claim 1, wherein the first heterophasic polypropylene (HECO1) has a melt flow rate MFR(1), measured according to ISO 1133, 230° C., 2.16 kg, ranging from 5 to 50 g/10 min.

4. The filled polyolefin composition according to claim 3, wherein the melt flow rate value MFR(1) is obtained by visbreaking the heterophasic polypropylene obtained from the polymerization reaction.

5. The filled polyolefin composition according to claim 1, wherein the intrinsic viscosity of the fraction soluble in xylene XSIV(1) of the first heterophasic polypropylene (HECO1) is equal to or lower than 1.5 dl/g.

6. The filled polyolefin composition according to claim 1, wherein the second heterophasic polypropylene (HECO2) has a melt flow rate MFR(2) measured according to ISO 1133, 230° C., 2.16 kg ranging from 90 to 120 g/10 min.

7. The filled polyolefin composition according to claim 1, wherein the glass fibers (b) have a diameter ranging from 5 to 50 μm and a length ranging from 0.1 to 10 mm.

8. The filled polyolefin composition according to claim 1, wherein the compatibilizer (c) is a polyolefin selected from the group consisting of polyethylenes, polypropylenes, and mixtures thereof, functionalized with a compound selected from the group consisting of maleic anhydride, C¹-C¹⁰ linear or branched dialkyl maleates, C¹-C¹⁰ linear or branched dialkyl fumarates, itaconic anhydride, C¹-C¹⁰ linear or branched itaconic acid, dialkyl esters, maleic acid, fumaric acid, itaconic acid, and mixtures thereof.

9. The filled polyolefin composition according to claim 1, comprising 0.1-15% by weight of an additive (d) selected from the group consisting of fillers, pigments, nucleating agents, extension oils, flame retardants, UV resistants, UV stabilizers, lubricants, antiblocking agents, waxes, and combinations thereof, wherein the amount of the additive (d) being based on the total weight of (a)+(b)+(c)+(d).

10. The filled polyolefin composition according to claim 1, further comprising from 0.5 to 20% by weight of a polymer (e) selected from the group consisting of:
propylene homopolymers,
propylene copolymers with an alpha-olefin of formula CH₂—CHR, wherein R is H or a linear or branched C²-C⁸ alkyl, comprising up to and including 12% by weight of monomer units deriving from the alpha-olefin, based on the weight of component (e),
saturated or unsaturated styrene or alpha-methylstyrene block copolymers, wherein the block copolymer comprises from 10 to 30% by weight of polystyrene, based on the weight of (e),
ethylene homopolymers,
ethylene copolymers with an alpha-olefin of formula CH₂═CHR, wherein R is a linear or branched C²-C⁸ alkyl, and
combinations thereof,
wherein the amount of polymer (e) is based on the total weight of (a)+(b)+(c)+(d)+(e).

11. The filled polyolefin composition according to claim 1, having a melt flow rate MFR(tot), measured according to ISO 1133, 230° C., 2.16 kg ranging from 10 to 50 g/10 min.

12. (canceled)

13. A process to produce a molded article comprising the steps of:
(I) melt blending the filled polyolefin composition of claim 1, thereby forming a molten filled polyolefin composition; and
(II) pushing the molten filled polyolefin composition into the cavity of a mold and solidifying the molten filled polyolefin composition inside the cavity.

14. An article comprising the filled polyolefin composition according to claim 1.

15. The article according to claim 16, selected from vehicle interior trims, vehicle exterior trims and under the hood articles.

16. The article according to claim 14, being an injection-molded article.
